(19) United States
(12) Patent Application Publication
(10) Pub. No.: US 2011/0054991 A1
(43) Pub. Date: Mar. 3, 2011

(54) Profile Based Content Creation

(76) Inventors: Carlos Orellana, Garden Grove, CA (US); Ivano Stamegna, Irvine, CA (US)

(21) Appl. No.: 12/845,090

(22) Filed: Jul. 28, 2010

Related U.S. Application Data
(60) Provisional application No. 61/229,388, filed on Jul. 29, 2009.

(51) Int. Cl. G06Q 30/00

(52) U.S. Cl. 705/14.23; 705/14.69; 705/14.71

(57) ABSTRACT

Systems and methods of combining digital promotions with independent incentives are presented. In some embodiments, a social network site can allow users to have multiple profiles, where each profile could be active or inactive. The profiles can also include one or more user attributes. As the user interacts with the social networking site, the site server can create advertisements comprising a promotion and independent incentives. When the user engages with the promotion the incentive can then be provided to the user. The site server can form the advertisements by comparing profiles or attributes of the user with those of the promotions or incentives.

This application claims the benefit of priority to U.S. provisional application having Ser. No. 61/229,388 filed on Jul. 29, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is web based creation of content.

### BACKGROUND

Given the advent of social networking sites, many advertisers have appreciated the power of advertising to individuals based on viewed content. Fewer advertisers have appreciated that advertising based on an individual's profile can be a more powerful form advertising.

It has yet to be appreciated that content can be automatically constructed and presented to an individual based on a dynamic profile. For example, an individual could have different profiles at any given time. A person might wish to have a “professional” profile while at work, a “student” profile while at school, or a “friends” profile. Advertising or other forms of content can be tailored to match the individual's current active profile. Furthermore, the profile information can be used to create many types of other content including yearbooks, corporate directories, family albums, or other types of content.

Therefore, there remains a considerable need for methods, systems, and configurations to provide profile-based content to individuals.

### SUMMARY OF THE INVENTION

The inventive subject matter provides apparatus, systems and methods in which one can promote goods and services by combining independent promotions and incentives. One aspect of the inventive subject matter is considered to include a method of promoting goods or services. The method can include providing a server, a social networking site server for example, storing one or more user profiles. It some embodiments a single user account can have multiple user profiles representing active or inactive profiles according to a desired persona. As a user interacts with the social networking site, the site server can obtain one or more digital promotions that are considered acceptable for display to the user, possibly based on the active profile of the user. In addition, one or more incentives (e.g., a gift, a premium, a comp, etc.) can be selected based on information in the user's profile. Preferably the incentive would entice the user to follow through with fully engaging with the promotion. The site server can combine the incentive with the promotion by linking them together as a single promotion content representing an aggregated advertisement. The site server can instruct or configure the user's computer to present the promotion content to the user, preferably within a browser application. The promotion content can be presented by presenting graphics, images, videos, audio, games, or other forms of content. If the user fully engages with the promotion and meets one or more defined conditions (e.g., clicks through, purchases, send contact info, etc.), the incentive can be provided to the user.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an example of an advertisement comprising a promotion and an independent incentive.

FIG. 2 is a schematic of a method for promoting goods and services.

### DETAILED DESCRIPTION

It should be noted that while the following description is drawn to a computer/server based social networking systems, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including combining distinct digital promotions and incentives into a single advertisement that can be displayed a presented to a consumer where such combinations of promotions and incentives would not ordinarily be combined.

ZoneIn2, Inc. of Huntington Beach, Calif., (see URL www.ZoneIn2.com) provides a suitable platform of the disclosed techniques. Other platforms that could benefit from the disclosed subject matter includes Twitter™, Facebook™, MySpace™, Google™, Yahoo!™, MSN™, or other web sites or internet portals.

One aspect of the inventive subject matter includes forming a social networking web site that allows users to bind more than one user profile to their user account. For example, a user could have a “professional”, “student”, or “friends” profile. The content displayed regarding the user can be managed based on a currently active profile. The users can also grant permission to access information based on active profiles. One should note that permission can be granted based on the active profile of the user or the active profile of another user. In some embodiments, users can establish new profile types. It is contemplated that newly created profile types would be best approved by the service to ensure that profile types are normalized across the web-based service or to reduce the proliferation of profile types. One should appreciate that the contemplated profile management services can be applied to many different computer systems beyond social networking web sites. Furthermore, one should appreciate that profiles are readily differentiated from merely have different accounts. Profiles are bound to a single account as opposed to representing a user account.

Another aspect of the inventive subject matter includes presenting advertising content to users based on user profile information. Preferably, the profile information includes normalized attributes where normalized attributes represent values used by the system to represent common concepts. For example, a user-define attribute of “have a job” or “currently working” could be more appropriately normalized to “employed” as represented by the system. Promotions can be presented to users based on their attributes, and incentives can be bound to the promotions to entice the users to fully engage with the promotion. In some embodiments, the incentive represents a second promotion. In other more preferred embodiments, the incentive is selected based one or more attributes of the user's active profile. It is also contemplated that such an incentive program can be provided to other third party sites as a service. For example, incentives can be bound to “Ads by Google”. The incentives can be changed from one viewing of a promotion to another viewing of the same promotion based on who is presented to the promotion, when the presentation is made, or other factors. Additional features include using the incentives as a scavenger hunt, a contest, a lottery of sorts, or other types of programs.

Still, another aspect of the inventive subject matter includes forming a directory content representing a listing of individuals. A directory can be formed by automatically identifying individuals that have at least one normalized attribute in common. For example, the users might have graduated from the same school. The users can then be organized, possibly hierarchically, by the year they graduated. Other directory content can include corporate directories, group directories, family trees, or other types of listings of individuals.

### Incentives

The following discussion describes one possible embodiment of an incentive advertising concept. Incentives are considered a form of advertisement enticing a consumer to follow through with purchasing a good or service in view of providing the user a gift or other compensation for engaging with the promotion. If a consumer purchases a good or service, they receive the incentive. Promotions are considered an advertisement promoting a good or service. As stated above, the inventive subject matter is considered to include combining one or more incentives with one or more independent promotions. Incentives are preferably independent of the promotion in the sense that they are both offered by independent, unaffiliated entities.

Based on the user's choices, preferences, or profiles a preferred social networking site has the ability to post several advertising banners on the website giving the user a direct targeted marketing with special incentives that match the user's preferences and interest. Preferred social networking sites have a survey system which asks questions to the users with a pre-set drop down list of brands, interests, hobbies, personal choices, or other normalized attributes that can be bound to one or more profiles of the user. From this list the users select what are their most preferable choices. The system uses the information to select advertisements or incentives from an ad server (e.g., local ad server, remote ad server, third party service, etc.) and matching the ads with the incentive ads and displaying them in the user's profiles.

One should appreciate the utility of combining an incentive with a promotion. Through the use of combining incentives with promotions, different brands can be cross-marketed together in a way that promotes brands/companies, and creates a win-win-win-win situation for all parties. The ads that are displayed receive a purchase when the user clicks on the banner and places the order. However, what motivated and made the user click on the banner ad and make a purchase was the incentive advertisement portion of ad. The incentives can be items such as a free music downloads from iTunes™, a Visa™ gift card, 100 reward points for the social networking site itself that can be redeemed for products or services. Preferably the social networking site receives a commission from the company that obtained a purchase from the user/client. The social networking site can pay the company/product that is promoted via the incentive. The social networking site can deliver the incentive to the user/client by sending a free music download code to the user/client to their social network site messaging in-box.

Therefore, all four parties (e.g., the user, social network site, advertiser providing the promotion, and the company providing the incentive) here are in a winning proposition:
1—An affiliate company receives a purchase
2—A user client gets a product or service and a free incentive.
3—The social networking site gets a commission from the affiliate company
4—The social networking site can purchase from another affiliate company to give away the free incentive to the user, leaving the social networking site a smaller margin of commission after reducing the cost for the incentive; however, this platform and concept is done in a social networking website where millions of users will be visiting on a daily basis. Therefore, making the concept of generating revenue from the long tail become true: the future of business is selling less of more.

The above disclosed concept can also be offered to other websites that would like to take advantage of this marketing and advertisement system of matching advertisements or links with incentive ads provided by a service combining promotions with incentives. An innovative marketing and advertising technology can be offered to:
1—Companies or brands that would like to advertise their products/services via a third party or
2—Websites that would like to display banner ads on their website that are related to their content and would like to make money instead of the same old Google AdSense™ system

Companies that choose to advertise and promote their services and products with such a service will have the opportunity to be either the advertiser or the entity offering the incentive ad. The placed advertisements can be dynamic and constantly rotating and changing from one sponsor ad to another and matching up with different incentives (e.g., brands) continuously as users log in to the social networking site or simply log on to surf the net.

Website publishers have the ability to choose what type of banners they wish to display on their websites from a library of banners designed or provided by the combining service. The combining service can charge a one time set-up fee for the application system and then can share the commission with each purchase made by the client/user that was driven by the particular website.

Such a service can also be used for birthday reminders to its members and users of their network and other affiliate websites. The birthday reminder can come with a logo or icon of the social networking site, the logo or icon indicating the origination of the combined brands, one being the advertiser and the other one being the incentive ad. For example, a message might read as follows:
“Yanet's Birthday is coming up on July 7^{th}. One of her favorite brands is Nike. Her favorite sport is Tennis. In her list of gifts she would like to receive this year is a new racquet. Click here to buy her a gift at Nike.com and receive a free music download from iTunes.”

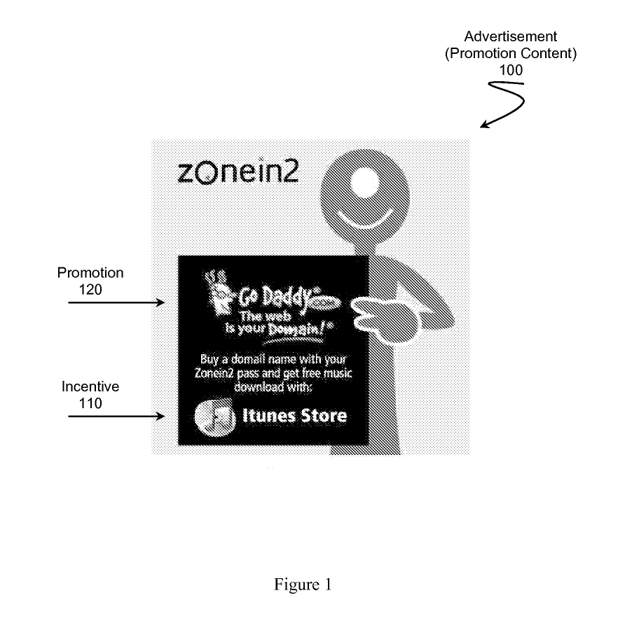

FIG. 1 presents a possible advertisement 100 that combines promotion 120 with incentive 110. In the example shown provided by ZoneIn2 Corporation, promotion 120 from GoDaddy® is combined with an incentive 110 for music from iTunes®. The combination can be determined by the system in numerous ways. For example, the system has determined that a user has an active profile that comprises attributes indicating an inclination for music. The system matches such user attributes with attributes of various incentives. When an acceptable incentive 110 is found, the incentive 110 can be combined with promotion 120 for form a single advertisement 100 that is presented to the user.

### Digital Directory

Contemplated social networking sites provide a new user with a short registration survey having a few questions. For example, questions might include where the user has gone or is currently attending school, the years attended, area of academic study, or a brief comment; the system will automatically allocate the user to a virtual directory (e.g., a listing of people) that fits entered parameters. For example, if you were a user where to reference attending Westminster High School from year 1992 to 1995, the system will allocate the user's picture or profile information to a virtual year book viewable only by those students who filled in the exact user profile attributes.

The same concept can be applied for people who complete a short registration survey of where they worked, name of company, type of company, years they worked at company, position or title and a brief comment; the system will automatically allocate a picture or profile in the company virtual directory book that fits the user's parameters. For example, if a user were to type in that they worked at Microsoft® Corporation from 2008 to present then the system will allocate the user in to Microsoft's virtual directory.

Preferred social networking sites also allow a user to upload photographs, videos, audios or all type of documents into a user defined folder, where the user can define a name to the folder. User's can furthermore set privacy (e.g., authorization, authentication, permissions, etc.) settings to each folder and its content so that only certain people are able to view the content based on their settings. Others can be restricted based on their profile attributes, including attributes of an active profile of the various users.

The system provides the user an ability to be able to print out the virtual yearbook at the end of the year. One can choose the cover of the book, choose a title and then purchase the book by placing the order via a publishing system.

### Providing Promotions and Incentives

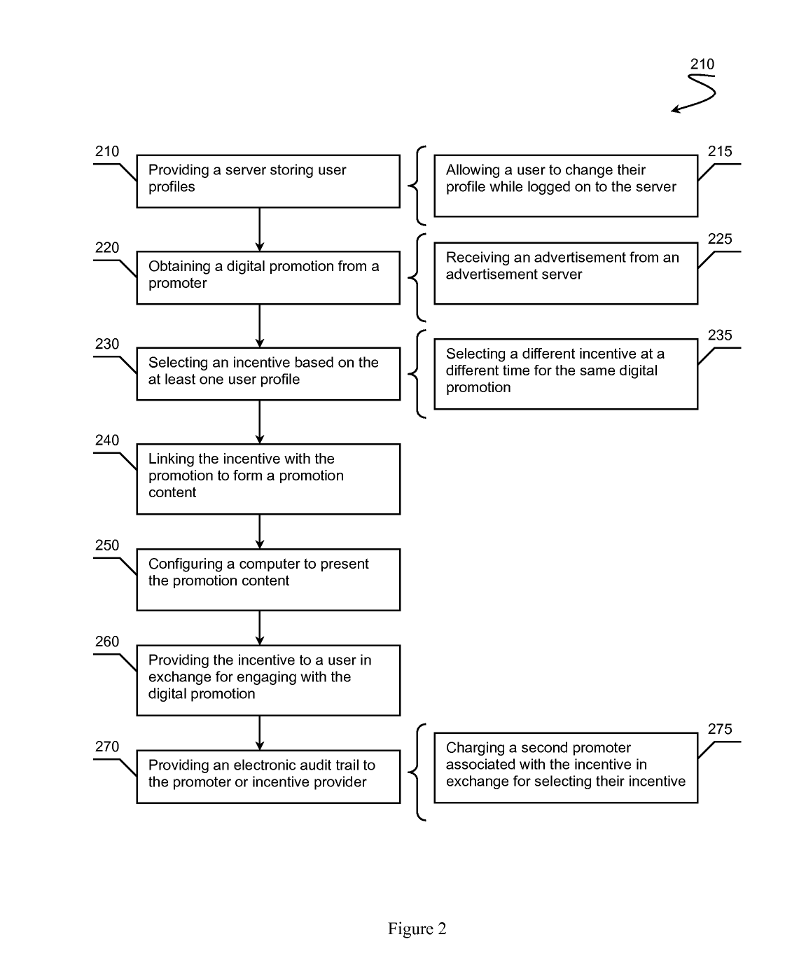

FIG. 2 presents a possible method 200 of promoting goods and services where a service can combine digital promotions with independently provided incentives. In a preferred embodiment, the service operates as a social networking site where promotions are combined with the incentives based on one or more profiles of a site user.

Step 210 can include providing one or more servers configured store one or more user profiles. The servers preferably provide access to social networking services to remote users over a packet switched network (e.g., the Internet, LAN, WAN, etc.). The user profiles can be stored in any suitable database system as desired. A user can have more than one profile where one of the profiles is considered active at any given time. Furthermore, the profiles can include one or more attributes, preferably normalized across the system, describing the user.

Step 215 contemplates that a user can change their profile while logged into the social networking site server. For example, a user can alter their preferences, values for their attributes, or otherwise modify one or more of their profiles. More preferably, the server allows the user to select which of their profiles is an active profile visible to others. The active profile represents a persona with which the user wishes to interact with others. Contemplated profiles could include a friend profile, a work profile, a student profile, a professional profile, or other types of profiles. Each of the profiles could comprise the same or different attributes depending on how a user of the system configures the profiles.

As users interact with the social networking site server, they can be presented one or more advertisements. Step 220 suggests obtaining a digital promotion from a promoter (e.g., advertiser) in preparation for constructing an advertisement for the user. For example, at step 225, the server could communicate with an advertisement server, either local or remote over a network, to receive a promotion or other type of advertisement. The advertisement could be obtained based on information available to the advertisement server including the user's active profile, user attributes, content viewed on the site server, or other information available to the site server or the advertisement server.

Step 230 continues building an advertisement for the user by selecting an incentive based on at least one of the user's profile, active or non-active. For example, the site server could correlate aspects of the user's profile (e.g., normalized attributes, usage pattern, geo-location, etc.) with similar attributes of one or more incentives. One should note that the incentives can be independent of the digital promotions. When an acceptable incentive has been found, the site server can prepare promotion content by aggregating the promotion and the incentive as a combined advertisement. One should note step 235 specifically suggests selecting a different incentive at a different time for the same digital promotion. A different incentive might be selected for various reasons. For example, a user might change their active profile, so that an incentive reflecting their current active profile might be more desirable. Additionally, an entity offering the incentive might pay more, or bid more in an auction, for the rights to have their incentives placed more often relative to other entities.

Step 240 indicates that the digital promotion and incentive are linked together to form a combined advertisement referenced as a “promotion content”. Linking the two types of content together can take on many different forms. In some embodiments, the site server can combine the two types of content into a single, unified advertisement appearing as a single piece of content. For example, the two types of content can be represented as a single graphic image, text block, audio stream, video stream, or other representation. FIG. 1 illustrates promotion content in the form of a single graphic image where a promotion and an incentive have been combined as a single graphic image. In other embodiments, the two types of content could be displayed in proximity to each other to form the promotion content.

Step 250 includes configuring a computer to present the linked promotion content. In a preferred embodiment, the social networking site server provides instructions (e.g., scripts, HTML, XML, etc.) or data (e.g., text, audio, graphics, video, etc.) to a user's computer. The instructions and data can be sent via suitable standard protocols (e.g., HTTP, HTTP, SSL, AES, etc.). The instructions and data inform a browser application on the user's computer to render the promotion content to the user.

One should note that the user is presented with both the promotion from the promoter and the incentive from a second, different promoter. The user can engage with the promotion as desired.

Step 260 includes providing the incentive to the user in response to the engagement with the promotion based on any desired conditions. In some embodiments, the incentive is provided to the user when the user purchases a good or service advertised within the promotion. The conditions for providing the incentive can also have a lower threshold, simply clicking on the promotion content for example. Furthermore, the social networking site server can determine the threshold conditions for providing the incentive based on the user's profile, possibly active profile, attributes. For example, a user that has been shown to be a highly loyal consumer could be provided the incentive for simply clicking through to the promotion where a less loyal consumer might require an actual purchase.

Step 270 specifically contemplates that providing an electronic audit trail to the promoter of the promotion or to the incentive provider. Providing an audit trail allows the various advertisers to determine a success of their advertising campaigns. Furthermore, the advertisers can determine if there is a correlation among user profiles, promotions, and the incentives. If there is a correlation, the advertisers can optimize their campaigns accordingly. In fact, the concept of providing incentive optimization tools via the social networking site server based on such correlations is considered to fall within the scope of the inventive subject matter. Step 275 can include charging the incentive provider (e.g., a promoter associated with incentive) in exchange for the site server selecting their incentive to be combined with the promotion.

### Additional Considerations

Table 1 presents additional subject matter directed to automatically generating a directory based on user profiles having normalized attributes. The additional subject matter is presented in the form of claims.

TABLE 1
Method of generating a directory

| Claim | Concept |
|---|---|
| 1 | A method of generating a directory content relating to |
| | individuals, the method comprising: |
| | providing a server storing a plurality of user profiles, wherein |
| | each profile comprises a set of normalized attributes; |
| | forming automatically a set of users as a function of the |
| | normalized attributes wherein each of the users have |
| | at least one common attribute from the set of normalized |
| | attributes; |
| | generating automatically a directory content based on the at |
| | least one common attribute and the set of users; and |
| | configuring a computer to present the directory content. |
| 2 | The method of claim 1, further comprising organizing the set |
| | of users into a hierarchal organization. |
| 3 | The method of claim 2, wherein the directory content |
| | comprises at least one of a yearbook, a corporate |
| | directory, a family tree, and a group membership. |
| 4 | The method of claim 1, further comprising enabling a user |
| | to order a hard copy of the directory content. |

Table 2 presents additional subject matter directed to a content providing service based on a server that manages one or more active profiles of registered users. The additional subject matter is presented in the form of claims.

TABLE 2
Content providing service.

| Claim | Concept |
|---|---|
| 1 | A content provider service, comprising: |
| | at least one computer server configured to: |
| | (a) store digital content on a computer readable storage media |
| | where the content is available to remote users over a packet |
| | switched network; |
| | (b) store user account information, wherein the account |
| | information includes a plurality of profiles for each user; and |
| | (c) configure a remote computer to present at least some of the |
| | digital content to at least one user as a function of a currently |
| | active profile of the at least one user. |
| 2 | The content provider service of claim 1, wherein the digital |
| | content includes content uploaded by at least some of the |
| | remote users. |
| 3 | The content provider service of claim 1, wherein the digital |
| | content comprises an incentive linked with a promotion. |

Thus, specific compositions and methods of the inventive subject matter have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of promoting goods and services via presenting promotion content, the method comprising:
providing a server storing a user profile;
obtaining a digital promotion from a promoter;
selecting an incentive based on the user profile;
linking the incentive with the digital promotion to form a promotion content;
configuring a computer to present the promotion content that includes the digital promotion with the incentive to the user; and
providing the incentive to the user in exchange for engaging with the digital promotion.

2. The method of claim 1, wherein the step of selecting the incentive is based on a current profile of a user having a plurality of user profiles stored on the server.

3. The method of claim 1, wherein the step of selecting the incentive is based on attributes within the user's profile.

4. The method of claim 3, further comprising charging a second promoter associated with the incentive a fee in exchange for selecting their incentive.

5. The method of claim 4, wherein the fee is a result of an auction.

6. The method of claim 1, further comprising selecting a different incentive for the digital promotion at a different time.

7. The method of claim 1, wherein the step of obtaining the digital promotion includes receiving an advertisement from an advertisement server.

8. The method of claim 1, wherein the promotion content comprises at least one of a text box, a banner, a link, an audio presentation, a video presentation, an image, an electronic communication, and a game.

9. The method of claim 1, wherein the step of linking the incentive with the digital promotion includes providing an electronic audit trail.

10. The method of claim 9, further comprising providing the audit trail to at least one of the promoter and a second promoter associated with the incentive.

11. The method of claim 10, further comprising electronically accepting payment from the at least one of the promoter and a second promoter.

12. The method of claim 1, wherein the step of configuring a computer to present the promotion content is conducted by a second server and wherein the computer is remote to the second server.

13. The method of claim 12, wherein the second server comprises at least one of the of following a social networking site, a search engine, a blog engine, a news server, an internet portal, a game server, an internet vendor site, a messaging site, and an electronic communication server.

14. The method of claim 1, further comprising allowing a user to change their profile while logged onto the server.
